(19) United States
(12) Patent Application Publication
(10) Pub. No.: US 2006/0057546 A1
(43) Pub. Date: Mar. 16, 2006

(54) Products, systems and methods for teaching educational subjects to young children

(75) Inventors: David C. Kravitz, Barrington Hills, IL (US); Mary Ellen Maunz, Algonquin, IL (US)

Correspondence Address: OLIFF & BERRIDGE, PLC, P.O. BOX 19928, ALEXANDRIA, VA, 22320, US

(73) Assignee: THE ACADEMY FOR EARLY CHILDHOOD DEVELOPMENT, Des Plaines, IL (US)

(21) Appl. No.: 11/089,552

(22) Filed: Mar. 25, 2005

Related U.S. Application Data
(63) Continuation of application No. 10/883,998, filed on Jul. 6, 2004.
Application No. 10/883,998 is a continuation of application No. 10/637,658, filed on Aug. 11, 2003, now abandoned.
(60) Provisional application No. 60/402,128, filed on Aug. 9, 2002.

(51) Int. Cl. G09B 19/00; G09B 1/00

(52) U.S. Cl. 434/169; 434/167

(57) ABSTRACT

Products, methods and systems for teaching various educational subjects, such as reading, mathematics, music, geography, to young children. In one exemplary embodiment, a method for teaching beginning reading to a beginning reader in a classroom setting, includes (a) providing one or more of a picture or game to a beginning reader, the one or more of a picture or game including a pictorial representation of a first learning object, (b) pronouncing to the beginning reader the picture or game, the pronouncing emphasizing with intonation single sound phonetically representative of the beginning letter of the object displayed on the picture or game. The method also includes repeating steps (a) and (b) to the student for a plurality of pictures or games having pictorial representations of objects other than the first learning object. The method further includes the step of asking the beginning reader to name the object, the student pronouncing with exaggerated intonation the single sound phonetically representative of the beginning letter of the object on the picture or game, and determining whether the beginning reader correctly pronounced the beginning letter.

This nonprovisional application claims the benefit of U.S. Provisional Application No. 60/402,128, filed Aug. 9, 2002.

### BACKGROUND OF THE INVENTION

1. Field of Invention

This invention generally relates to products, systems and methods for teaching various educational subjects, such as reading, mathematics, music, geography, to young children.

2. Description of Related Art

Existing products, systems and methods used for teaching educational subjects to young children are generally structured so that they require significant interaction from/with an adult instructor. Further, existing educational computer products, such as those electronic/computer products for use in a home environment, are either fairly static, i.e., they have a 2-D configuration that requires minimal interaction from the young user, or are too complex to be used by young children of ages between 4-8 years old.

### SUMMARY OF THE INVENTION

This invention provides products, systems and methods for teaching educational subjects, including reading, math, geography, music, to young children in pre-kindergarten through kindergarten school grades.

This invention provides products, systems and methods for teaching educational subjects, including reading, math, geography, music, to young children using a computer implemented environment.

This invention provides products, systems and methods for teaching educational subjects, including reading, math, geography, music, to young children using a 3-D computer game environment.

This invention provides products, systems and methods for teaching educational subjects, such as reading, to young children, particularly pre-first grade and pre-kindergarten students, in a classroom-like setting or environment.

In various exemplary embodiments, the products, systems and methods of this invention teach reading to a beginning reader by first providing phonemic awareness instruction to the beginning reader to allow the beginning reader to learn a single sound representative of a beginning letter or phoneme associated with a displayed or presented object.

In various exemplary embodiments, providing phonemic awareness instruction includes providing one or more of a picture or game to the beginning reader, the one or more of a picture or game including a pictorial representation of a displayed object; pronouncing to the beginning reader the displayed object, the pronouncing emphasizing with exaggerated intonation the single sound phonetically representative of the beginning letter of the object name displayed on the picture or game, without necessarily identifying that letter.

In various alternative embodiments, providing phonemic awareness instruction includes providing one or more of an audio recording or song that includes a tune of a familiar nursery rhyme to the beginning reader, and providing one or more spoken instructions that will instruct the beginning reader to pronounce or enunciate with emphasis a single sound phonetically representative of a beginning letter of a personal character presented by the audio recording or song.

This invention provides products, systems and methods for teaching reading to beginning readers based on educational games and activities to provide phonemic awareness instruction to the beginning reader to allow the beginning reader to learn a single sound representative of a beginning letter or phoneme associated with an displayed or presented object.

Products, systems and methods according to this invention further provide instructions to the beginning reader to allow the beginning reader to associate the single sound phonetically representative of the beginning letter of the object displayed or presented in the educational game or activity to a corresponding letter in an alphabet, preferably the English alphabet but also including other language alphabets such as Spanish, French, Cyrillic, Arabic or even computer alphabets such as GRAFFITI™.

Products, systems and methods according to this invention further provide instructions to the beginning reader to allow the beginning reader to phonetically blend and segment the displayed or presented object's name using the beginning letter such that the beginning reader learns to read a plurality of individual words.

Products, systems and methods according to this invention further provide instructions to the beginning reader to allow the beginning reader to learn a single sentence reading by providing sentences that include two or more individual words selected from the plurality of individual words.

In various embodiments, products, systems and methods according to this invention provide instructions representative of one or more of phonetic awareness group, letter mastery group, word mastery group, sentence mastery group and a combined group of sounds, letters, words and sentences.

In various embodiments, products, systems and methods according to this invention provide tools for practicing such methods and components of such systems.

### BRIEF DESCRIPTION OF THE DRAWINGS

FIG. 1 illustrates a functional block diagram of one exemplary embodiment of a computer based implementation of a system for used to teach an educational subject such as reading.

### DETAILED DESCRIPTION OF PREFERRED EMBODIMENTS

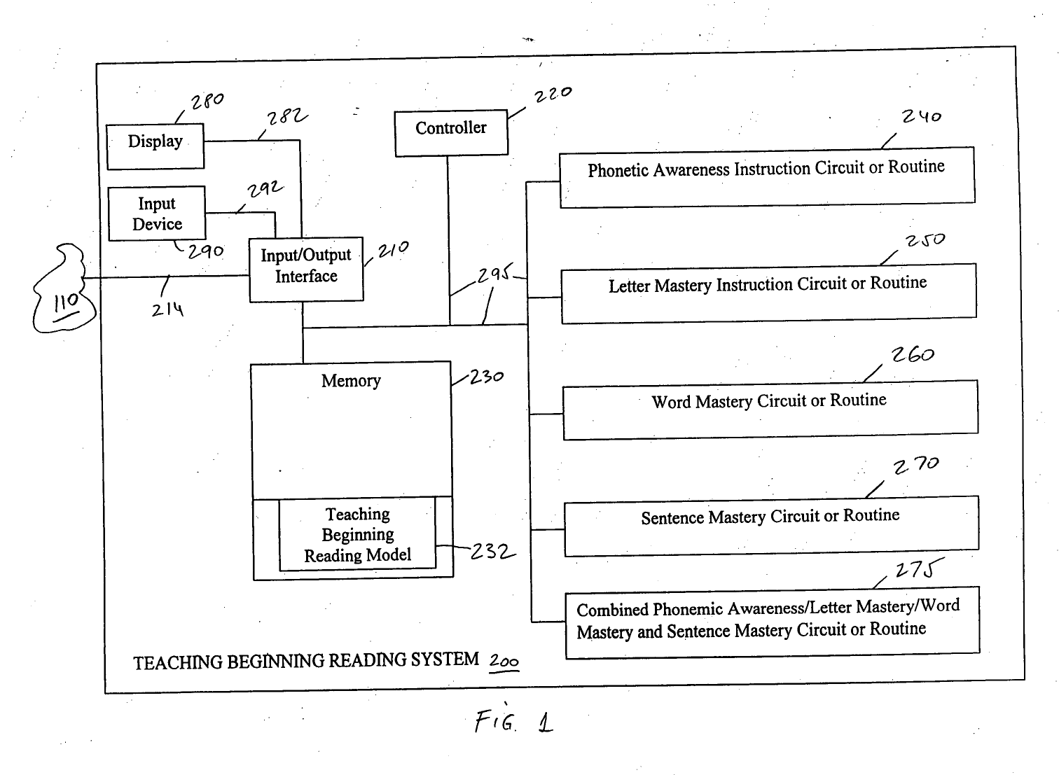

FIG. 1 illustrates a functional block diagram of one exemplary embodiment of a computer based implementation of a teaching beginning reading system 200. It will be appreciated that the system 200 may by modified and/or implemented for teaching any educational subject, including, but not limited to, beginning reading, beginning math, music, geography, science.

In one exemplary embodiment, the teaching beginning reading system 200 may be a stand alone configuration of it may connect to a network 110 via the link 214. The link 214 can be any known or later developed device or system for connecting the teaching beginning reading 200 to the network 110, including a connection over public switched telephone network, a direct cable connection, a connection over a wide area network, a local area network, a storage area network, a connection over an intranet or an extranet, a connection over the Internet, or a connection over any other distributed processing network or system. In general, the link 214 can be any known or later developed connection system or structure usable to connect the teaching beginning reading system 200 to the network 110.

As shown in FIG. 1, the teaching beginning reading system 200 includes one or more display devices 280 usable to display information to the user, and one or more user input devices 290 usable to allow the user or users to input data into the teaching beginning reading system 200. The one or more display devices 280 and the one or more input devices 290 are connected to the teaching beginning reading system 200 through an input/output interface 210 via one or more communication links 282 and 292, respectively, which are generally similar to the link 214 above.

In various exemplary embodiments, the teaching beginning reading system 200 includes one or more of a controller 220, a memory 230, a teaching beginning reading model 232, a phonetic awareness instruction circuit or routine 240, a letter mastery instruction circuit or routine 250, a word mastery circuit or routine 260, and a sentence mastery circuit or routine 270, all of which are interconnected over one or more data and/or control buses and/or application programming interfaces 295. In various exemplary embodiments, the teaching beginning reading system 200 includes a combined phonemic awareness/letter mastery/word mastery and sentence mastery circuit or routine 275, which is also connected to the one or more data and/or control buses and/or application programming interfaces 295. In various exemplary embodiments, the teaching beginning reading model 232 is stored in memory 230 of the teaching beginning reading system 200.

The controller 220 controls the operation of the other components of the teaching beginning reading system 200. The controller 220 also controls the flow of data between components of the teaching beginning reading system 200 as needed. The memory 230 can store information coming into or going out of the teaching beginning reading system 200, may store any necessary programs and/or data implementing the functions of the teaching beginning reading system 200, and/or may store data and/or teaching beginning reading information at various stages of processing.

The memory 230 includes any machine-readable medium and can be implemented using appropriate combination of alterable, volatile or non-volatile memory or non-alterable, or fixed, memory. The alterable memory, whether volatile or non-volatile, can be implemented using any one or more of static or dynamic RAM, a floppy disk and disk drive, a writable or re-rewriteable optical disk and disk drive, a hard drive, flash memory or the like. Similarly, the non-alterable or fixed memory can be implemented using any one or more of ROM, PROM, EPROM, EEPROM, an optical ROM disk, such as a CD-ROM or DVD-ROM disk, and disk drive or the like.

In various exemplary embodiments, the teaching beginning reading system 200 includes the-teaching beginning reading model 232 which the teaching beginning reading system 200 uses to provide instructions to a beginning reader or teacher using the various circuits or routines 240, 250, 260, 270 and/or 275.

The phonetic awareness instruction circuit or routine 240 is activated by the controller 220 to provide phonemic awareness instruction to the beginning reader to allow the beginning reader to learn a single sound representative of a beginning letter or phoneme associated with a presented or displayed object.

The letter mastery instruction circuit or routine 250 is activated by the controller 220 to provide instructions to the beginning reader to allow the beginning reader to associate the single sound phonetically representative of the beginning letter of the object name displayed on the picture or game to a corresponding letter in the alphabet.

The word mastery circuit or routine 260 is activated by the controller 220 to provide instructions to the beginning reader to allow the beginning reader to phonetically blend and segment the presented or displayed object's name using one or more of the beginning letter and a second letter such that the beginning reader learns to read a plurality of individual words.

The sentence mastery circuit or routine 270 is activated by the controller 220 to provide instructions to the beginning reader to allow the beginning reader to learn single sentence reading by providing sentences that include two or more individual words selected from the plurality of individual words.

The combined phonemic awareness/letter mastery/word mastery and sentence mastery circuit or routine 275 is activated by the controller 220 to provide instructions to the beginning reader to allow the beginning reader to apply phonemic awareness and letter recognition to build phonetic words using one or more beginning reading techniques, such as, for example, building phonetic words and/or sentences using one to one correspondence of one letter per sound.

In one exemplary embodiment, the method of teaching beginning reading to a beginning reader in a classroom setting includes (a) providing one or more of a picture or game to a beginning reader, the one or more of a picture or game including a pictorial representation of a first learning object. The method further includes the step of (b) pronouncing to the beginning reader the picture or game, the pronouncing emphasizing with intonation a single sound phonetically representative of the beginning letter of the object displayed on the picture or game. The method may also include repeating steps (a) and (b) to the student for a plurality of pictures or games having pictorial representations of objects other than the first leading object. The method may further include the step of asking the beginning reader to name the object, the student pronouncing with exaggerated intonation the single sound phonetically representative of the beginning letter of the object on the picture or game, and determining whether the beginning reader correctly pronounced the beginning letter.

In an alternative embodiment, method of teaching beginning reading to a beginning reader in a classroom setting includes (a) providing a set of written materials including at least an instructional board having one or more of a letter, word, picture, symbol or a combination thereof displayed thereon; (b) visually specifying to the reader a single letter, word, picture, symbol or combination selected from the one or more of a letter, word, picture or symbol displayed on the board; (c) reading aloud to the student the single letter or a beginning letter of the single word, picture, symbol or combination thereof, the reading aloud emphasizing with exaggerated intonation a single sound phonetically representative of the letter displayed on the board or representative of the beginning letter of the word, picture or symbol displayed on the board; (d) repeating steps (b) and (c) to the student for a plurality of letters, words, pictures, symbols or combinations thereof displayed on the instructional board or displayed on one or more subsequent instructional boards; (e) asking the student to read aloud the single letter displayed on the board or the beginning letter of the single word, picture, symbol or combination thereof, the student reading aloud emphasizing with exaggerated intonation the single sound phonetically representative of the letter or the beginning letter; (f) determining whether the reader correctly identified the letter or the beginning letter by comparing the read aloud letter or beginning letter to a corresponding alphabet letter; (g) correcting the student's reading aloud of the single letter or the beginning letter when an instructor determines that the letter or the beginning letter was incorrectly identified during-read aloud session; and (h) repeating steps (b)-(g) until the student correctly reads aloud the single letter or the beginning letter of the single word, picture, symbol or combination thereof displayed on the board.

In another alternative embodiment, method of teaching beginning reading to a beginning reader in a classroom setting includes (a) providing a set of written materials including at least an instructional board having a word, picture or a combination thereof displayed thereon; (b) reading aloud to the student the word, the reading aloud emphasizing with intonation sound groups representative of phonetic segmentation portions of the word displayed on the board; (c) repeating steps (a)-(b) to the student for a plurality of instructional boards having a word, picture or a combination thereof displayed; (d) asking the student to read aloud the single word, the student reading aloud emphasizing with exaggerated intonation sound groups representative of phonetic segmentation portions of the word displayed on the board; (e) determining whether the reader correctly identified proper phonetic segmentation portions of the word displayed on the board; (f) verbally correcting the student's reading aloud of the word when an instructor determines that the phonetic segmentation portions of the word were incorrectly identified during read aloud session; and (g) repeating steps (a)-(f).

The computer based implementation of a teaching beginning reading system 200 is based at least on materials and information from the applications included in the “Pathway to Early Reading” materials, all of which are incorporated herein by reference, in their entirety:

AlphaBits™ Letter Formation Song: 26 songs—original lyrics sung to melodies in the public domain. One song for each alphabet letter. Song lyrics describe how letters are formed.

Introductory AlphaBits™ Letter Character Book

Set of 26 AlphaBit™ For Kids Vocabulary Books

Set of 26 AlphaBits™ For Kids Alliterative Books

Barney Beaver Bunny Buddy

AlphaBits™ Letter Formation Practice Sheets—13 laminated 8×11 sheets, 2 letters per sheet wherein children can listen to the songs (referenced above) and practice tracing (with fingers) and writing letters. Designed to be “write and wipe-able”.

Foundations of Literacy flipcharts—volume 1 and volume 2. Targeted to pre-K market. 39 laminated 22″×17″ pages (both volumes), including 26 pages of Air Writers™.

Kindergarten Teacher Manual—teacher introduction, original content teacher instruction pages on early childhood literacy theory, and day by day instruction on Kindergarten curriculum

Pre-Kindergarten Teacher Manual—week by week teacher instructions for Center Suggestions and Circle Time Activities. Includes original content teacher instruction pages on early childhood literacy theory. Also includes suggestions for ancillary games, sensory table activities, read-alouds, phonemic awareness and letter activities.

Pathway to Early Reading Complete Game Pack—15 different original games designed to teach phonemic awareness skills, letter knowledge, word reading, and sentence comprehension:
Bendy Action Game for 3 letter words
Bendy Action Game for 4 letter words
The Big Board Game—Rhyming
The Big Board Game—Beginning Sounds
The Big Board Game—Sounds to Letters
The Big Board Game—Lower Case to Upper Case
The Big Board Game—3 Letter Words
The Big Board Game—4 Letter Words,
Alpha Lotto—Rhyming
Alpha Lotto—Beginning Sounds
Alpha Lotto—Hear the Sounds
Alpha Lotto—Letters
Alpha Lotto—Animal Words
Alpha Lotto—Sight Words
Alpha Lotto—Phrases

Each “Bendy Action” game consists of an originally designed game board, several bendy figures and 24 calling cards

Each “Big Board” game has an originally designed game board, 30 calling cards and game pieces to move about the board.

Each “Alpha Lotto” game has between 9 and 18 game boards and 25 to 30 calling cards.

AlphaBit World Chart

Laminated wall chart approx 3′×2′ with original artwork of world and Company's letter characters placed at various sites throughout. To be used with young children as an activity to introduce vocabulary, Company's proprietary letter characters, letters and their sounds

Kindergarten assessment book—16 page booklet with diagrams and artwork designed to assess children's mastery of rhyming, sound identification, letter formation, name writing, segmenting and blending words, reading decodable text

Pre-Kindergarten assessment book—12 page booklet with diagrams and artwork designed to assess children's mastery of sound identification, rhyming, letter knowledge and formation, segmenting and blending words, and word decoding

Large Picnic Letter Placement—8′×8.5″ laminated poster with picnic graphics and 26 strategically placed velcro spots designed to accept to up to 26 5″ letters and/or 26 5″ letter characters. Accompanies a picnic legend unique to the Company that tells a story illustrating beginning sounds and letters. Graphically demonstrates where the letters sit on the lines.

Touch and Writes—Set of half page hand-writing practice sheets featuring each letter and its letter character and graduated tracing forms from broken lines to beginning stroke to starting point

Eight Training Modules
Introduction to Pathway to Early Reading™
Foundations of literacy
The Literate-Rich Environment
Research—Why we teach sounds and letters
Phonological and Phonemic Awareness
Letter Knowledge/Letter Mastery
Word Recognition
Reading for Meaning.

In various exemplary embodiments, the products, systems and methods for teaching educational subjects, including reading, math, geography, music, science, to young children, use a 3-D computer game environment. The game products are specifically for children between the ages of 3 and 7.

In various exemplary embodiments, the game products teach key foundational educational topics in a fun and interactive way. That is, leading with games/interactive activities teaching early literacy skills, then following with other subjects—math, science, health, geography, music, age-appropriate social skills, ethical behaviors, and games teaching an understanding of money and commerce.

In various exemplary embodiments, the game products use established game platforms, such as those for Sony's PlayStation 2, Nintendo's GameCube, and Microsoft's Xbox.

In various exemplary embodiments, the game products will employ a custom-designed controller device that is ergonomically and developmentally appropriate for smaller, less coordinated hands. Features will include, for example, bigger push button controls in bright primary colors.

In various exemplary embodiments, the game products will use game graphics specifically designed to appeal to young children, which will include three dimensionally rendered, strong elements of realism, and other features.

In various exemplary embodiments, the game products will employ game contents that will integrate charming, original letter and original number characters into activities and stories. Games will also include progressively more difficult levels of interaction.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method of teaching beginning reading to a beginning reader in a classroom setting, the method comprising:
(a) providing one or more of a picture or game to a beginning reader, the one or more of a picture or game including a pictorial representation of a first learning object;
(b) pronouncing to the beginning reader the picture or game, the pronouncing emphasizing with intonation a single sound phonetically representative of the beginning letter of the object displayed on the picture or game;
(c) repeating steps (a) and (b) to the student for a plurality of pictures or games having pictorial representations of objects other than the first learning object;
(d) asking the beginning reader to name the object, the student pronouncing with exaggerated intonation the single sound phonetically representative of the beginning letter of the object on the picture or game; and
(e) determining whether the beginning reader correctly pronounced the beginning letter.

2. A method of teaching beginning reading to a beginning reader in a classroom setting, the method comprising:
(a) providing a set of written materials including at least an instructional board having one or more of a letter, word, picture, symbol or a combination thereof displayed thereon;
(b) visually specifying to the reader a single letter, word, picture, symbol or combination selected from the one or more of a letter, word, picture or symbol displayed on the board;
(c) reading aloud to the student the single letter or a beginning letter of the single word, picture, symbol or combination thereof, the reading aloud emphasizing with exaggerated intonation a single sound phonetically representative of the letter displayed on the board or representative of the beginning letter of the word, picture or symbol displayed on the board;
(d) repeating steps (b) and (c) to the student for a plurality of letters, words, pictures, symbols or combinations thereof displayed on the instructional board or displayed on one or more subsequent instructional boards;
(e) asking the student to read aloud the single letter displayed on- the board or the beginning letter of the single word, picture, symbol or combination thereof, the student reading aloud emphasizing with exaggerated intonation the single sound phonetically representative of the letter or the beginning letter;
(f) determining whether the reader correctly identified the letter or the beginning letter by comparing the read aloud letter or beginning letter to a corresponding alphabet letter;
g) correcting the student's reading aloud of the single letter or the beginning letter when an instructor determines that the letter or the beginning letter was incorrectly identified during read aloud session; and
(h) repeating steps (b)-(g) until the student correctly reads aloud the single letter or the beginning letter of the single word, picture, symbol or combination thereof displayed on the board.

3. The method of claim 1, wherein the steps are implemented in a 3-D computer game environment.
